(19) United States
(12) Patent Application Publication
(10) Pub. No.: US 2003/0132635 A1
(43) Pub. Date: Jul. 17, 2003

(54) Gravity driven electric power generator

(76) Inventor: George Ganimian, Dorchester, MA (US)

Correspondence Address: LAMBERT & ASSOCIATES, P.L.L.C., 92 STATE STREET, BOSTON, MA, 02109-2004, US

(21) Appl. No.: 10/047,126

(22) Filed: Jan. 14, 2002

(51) Int. Cl. H02P 9/04

(52) U.S. Cl. 290/1 R

(57) ABSTRACT

An electric power generator harvesting the gravitational pull of the Earth, having a platform member, an electric generator housing slidably positioned on the platform member, the electric generator housing coupled to an axle having a rotor gear, an endless belt having tread members, a drive wheel, and an idler wheel, wherein the rotor gear is in mating contact with the tread member of the endless belt. Change of orientation of the platform member along a horizontal longitudinal axis causes the electric generator housing to slide on the platform member while the counter motion of the rotating endless belt maintains position of the electric generator housing on the platform member. As a result of rotation of the axle, electric power is generated by turbine generator located inside of the electric generator housing. Some of the generated electric power could be utilized to supply the needed power for rotation of the drive wheel rotating the endless belt. Hence, the electric power generator is capable of being self-sustaining.

### FIELD OF THE INVENTION

This invention relates to electric generators. In the past, a variety of generators where invented to satisfy our growing need for electric power. Such generators included turbine steam generators and water turbines. However, none of the previously invented generators utilized the power of the gravitational force in a self-sustaining manner. Although water turbines harness the power of the falling water, they are not self-sustaining in that they constantly require new volumes of falling water to power the generators. What is needed is an electric generator capable of harnessing the force of gravitational pull of the Earth in a self-sustaining fashion. This type of generator would be capable of producing substantial amounts of electric power without consumption of any external power source such as fuel.

### SUMMARY OF THE INVENTION

The present invention represents an electric generator harvesting the power of the gravitational pull of the Earth. The generator is comprised of a platform member, having a horizontal longitudinal axis and means for changing of an angle of orientation of the platform member along the horizontal longitudinal axis. An endless belt is integrated with the platform member, having a drive wheel and an idler wheel. An outer surface of the endless track belt has longitudinally spaced tread members. A means for rotating of the drive wheel of the endless belt is positioned on the platform member, such as a well known in the art motor to drive rotation of the work wheel. An electric generator housing is slidably mounted on the platform member. The electric generator housing houses almost any kind of a well known in the art electric generator that is similar to a well known in the art water turbine generator. The electric generator housing has at least one axle journalled for rotation between bearings contained in a generator housing, the axle having an external end protruding from a side of the generator housing. A rotor gear is coupled to the external end of the axle, wherein the rotor gear is in mating contact with the tread members of the endless belt.

To initiate operation of the electric power generator, the orientation of the platform member is changed along the horizontal longitudinal axis. The position of the platform member is changed from a flat horizontal position of 0° to a small angle of about 2°-10°. Such means as a well known in the art support jack is used to change the orientation of the platform member. The change in the orientation of the platform member causes the electric generator housing to slide down along the platform member. Simultaneously with a change in the orientation of the platform member, the rotation of the endless belt is started by activating the means for rotating of the drive wheel of the endless belt. The tread members on the endless belt exert pressure on the rotor gear coupled to the axle, thereby maintaining the electric generator housing on the platform member and preventing it from sliding off from the platform member. Moreover, the resultant rotation of the rotor gear causes rotation of the axle and the rotational work exerted by the axle is converted to an electric current by the turbine generator located inside of the electric generator housing. Therefore, the disclosed design of the generator allows to continuously harness the power of the gravitational pull of the Earth on the electric generator housing. To increase the output of the generator, one needs only increase the angle of orientation of the platform member. Some of the electric power produced by the generator could be routed to power the means for rotating of the drive wheel, which in turn rotates the endless belt. Therefore, the disclosed generator could be operated in a self-sustaining fashion without a need for an outside energy source.

In a preferred embodiment, a plurality of electric generator housings is positioned on the platform member to harness greater amount of electric power. The electric generator housings could be arranged in tandems, sharing a common axle called a joint axle positioned between the electric generator housings.

Therefore, it is the object of the present invention to provide an electric generator powered by the gravitational force.

It is another object of the present invention to provide an electric generator that is capable of self-sustainable electric power production without utilization of an external power source after initial start up of the generator.

It is yet another object of the present invention to provide an electric generator that utilizes a plurality of electric generator housings for greater yield of electric power.

### BRIEF DESCRIPTION OF DRAWINGS

These and other features, aspects and advantages of the present invention will become better understood with reference to the following description, appended claims, and accompanying drawings where:

FIG. 1 is a top view of one of the embodiments of the electric power generator.

FIG. 2 is a side cross-sectional view of one of the embodiments of the electric power generator at rest, showing some of the key components of the electric power generator.

FIG. 3 is a side cross-sectional view of one of the embodiments of the electric power generator at work, showing some of the key components of the electric power generator.

FIG. 4 is a prospective view of the preferred embodiment of the electric power generator.

### DESCRIPTION OF THE INVENTION

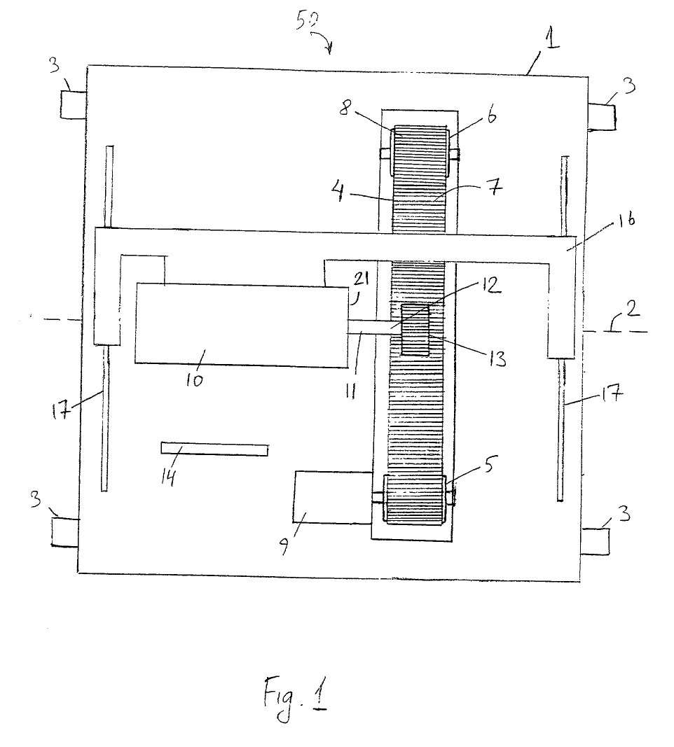

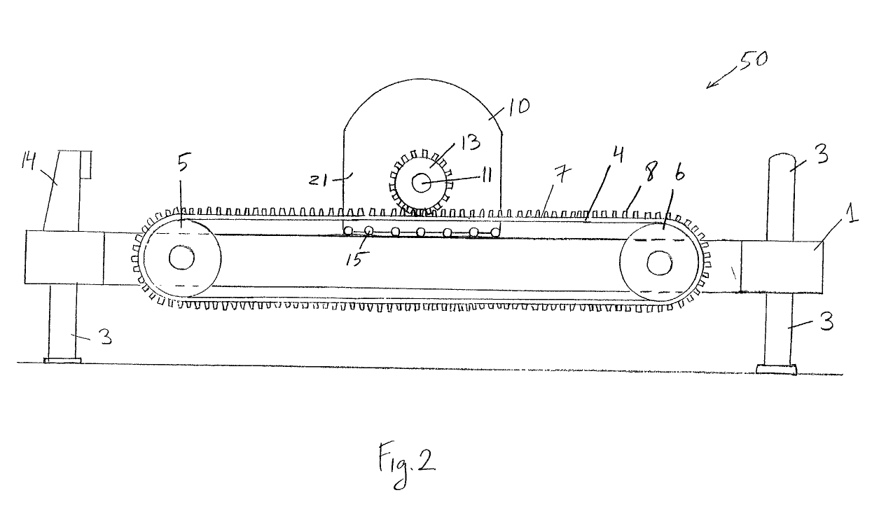

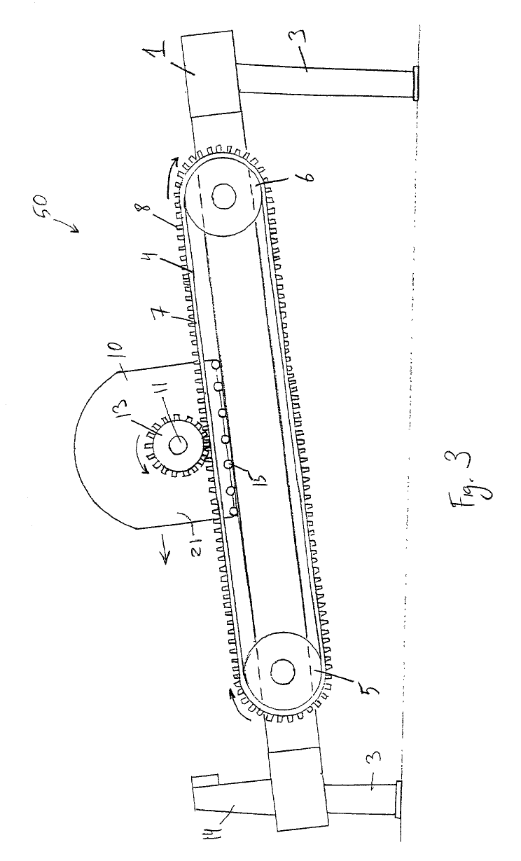

This invention represents an electric power generator 50 depicted in FIGS. 1-4. A simple and basic structure of the electric power generator is shown in FIGS. 1-3. The electric power generator 50 has a platform member 1 with a horizontal longitudinal axis 2 depicted in FIG. 1. A means well known in the art, such as support jacks 3, are used for changing orientation of the platform member 1. An endless belt 4 is integrated with the platform member 1. The endless belt 4 is supported by a drive wheel 5 and an idler wheel 6. An outer surface 7 of the endless belt 4 has longitudinally spaced tread members 8. The drive wheel 5 is powered by a means well known in the art for rotating of the drive wheel 5, such as a motor 9. An electric generator housing 10 is slidably mounted on the platform member 1. The electric generator housing 10 houses almost any kind of a well known in the art electric generator that is similar to a well known in the art water turbine generator. A plurality of rollers 15, shown in FIGS. 2-4, is located between the electric generator housing 10 and the platform member 1, thus allowing the electric generator housing 10 to slide on the platform member 1. An axle 11 is journalled for rotation between bearings contained in the electric generator housing 10, the axle 11 having an external end 12 protruding from a side 21 of the electric generator housing 10. A rotor gear 13 is coupled to the external end 12 of the axle 11, wherein the rotor gear 13 is in mating contact with the tread members 8 of the endless belt 4. A frame member 16 coupled to the electric generator housing 10 could be used to give further stability to the electric generator housing 10, wherein the frame member 16 is slidably positioned on the platform member 1 over rails 17, where rail members 17 are positioned on the platform member 1.

To start operation of the electric power generator 50, the orientation of the platform member 1 is changed along the horizontal longitudinal axis 2. The position of the platform member 1 is changed from a flat horizontal position of 0° to a small angle of about 2°-10°. Such means as a well known in the art support jack 3 is used to change the orientation of the platform member 1. The change in the orientation of the platform member 1 causes the electric generator housing 10 to slide down along the platform member 1. Contemporaneously with a change in the orientation of the platform member 1, the rotation of the endless belt 4 is started by activating the means for rotating of the drive wheel 5 of the endless belt 4. The tread members 8 on the endless belt 4 exert pressure on the rotor gear 13 coupled to the axle 11, thereby maintaining the electric generator housing 10 on the platform member 1 and preventing the electric generator housing 10 from sliding off from the platform member 1. In case of an improper operation of the electric power generator 50 where the speed of rotation of the endless belt 4 is not sufficient to keep the electric generator housing 10 on the platform member 1, a bumper stop 14 could be mounted on the platform member 1 to stop the electric generator housing 10 from sliding off the platform member 1.

Most significantly, the resultant rotation of the rotor gear 13 causes rotation of the axle 11 and the rotational work exerted by the axle 11 is converted to an electric current by the turbine generator located inside of the electric generator housing 10 through means well known in the art. Thus, the disclosed design of the electric power generator 50 allows to continuously harness the power of the gravitational pull of the Earth on the electric generator housing 10. To increase the output of the electric power generator 50, one needs only increase the angle of orientation of the platform member 1 with simultaneous corresponding increase in speed of rotation of the endless belt 4 so as to maintain position of the electric generator housing 10 on the platform member 1. Additionally, one can increase the weight of the electric generator housing 10 to increase the gravitational force exerted on the electric generator housing 10, thereby increasing the speed of rotation of the axle 11, which in turn translates into greater production of electric power by the turbine generator located inside of the electric generator housing 10.

Some of the electric power produced by the electric power generator 50 could be routed to power the means for rotating of the drive wheel 5, which drive wheel 5, in turn, rotates the endless belt 4. Therefore, the disclosed electric power generator 50 could be operated in a self-sustaining fashion without a need for an outside energy source.

### DESCRIPTION OF THE PREFERRED EMBODIMENT

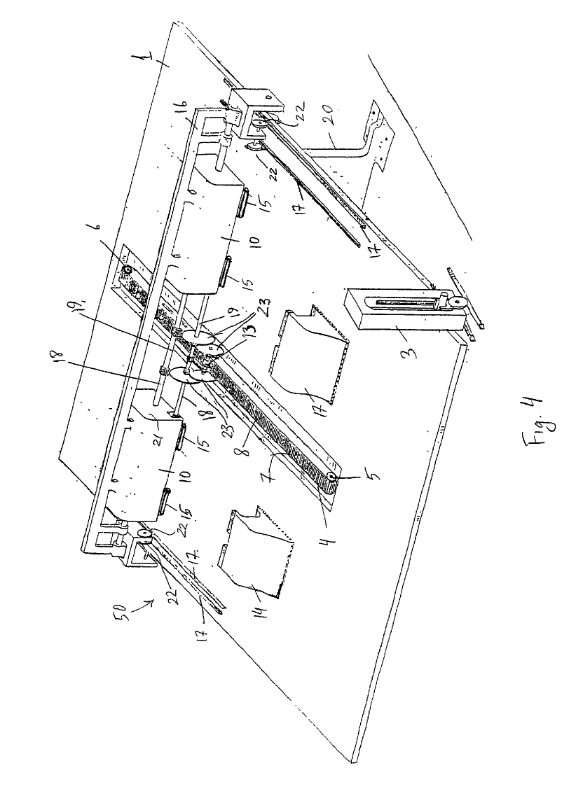

The preferred embodiment of the invention is shown in FIG. 4. It has essentially all the elements described above with exception of some improvements and modifications described below.

In the preferred embodiment, a stand 20 is utilized to support the platform member 1, while the support jack 3 is used to change orientation of the platform member 1. Here, the goal is to harness greater amount of electrical power by slidably placing a plurality of electric generator housings 10 on the platform member 1. The electric generator housings 10 are kept in alignment with respect to each other and the platform member 1 through coupling of the electric generator housings 10 to the frame member 16. The frame member 16 is slidably positioned on the platform member 1. Such well known in the art means for slidably positioning the frame member 16 on the platform member 1 as rail wheels 22 and rails 17 could be utilized, wherein the rail wheels 22 are coupled to the frame member 16 and the rails 17 are incorporated into the platform member 1.

Additionally, in the preferred embodiment the electric generator housings 10 are arranged in series where a number of electric generator housings 10 utilize same joint axle 18 journalled for rotation between bearings contained in the electric generator housings 10. Furthermore, more than one joint axle 18 could be journalled for rotation between bearings contained in the electric generator housings 10. The rotor gear 13 is located in a central external portion 19 of the joint axle 18, and joint axles 18 could each have its own rotor gear 13 placed in a mating contact with the tread members 8 of the endless belt 4. Alternatively, only one joint axle 18 could be coupled to a rotor gear 13, wherein translational gears 23 drive rotation of the joint axle 18 lacking a rotor gear 13. Similarly, the rotor gear 13 could be coupled to the joint axle 18 not through direct attachment depicted in FIGS. 1-3, but rather through a series of translational gears 23 as shown in FIG. 4.

By having more that one electric generator housing 10 and more that one joint axle 18, the disclosed preferred embodiment allows to harness greater amount of electrical power from operation of the electric power generator 50.

What I claim is:

1. An electric power generator, comprising:
a platform member, having a horizontal longitudinal axis and means for changing of an angle of orientation of the platform member along the horizontal longitudinal axis;
at least one endless belt integrated with the platform member, having at least one drive wheel and at least one idler wheel, wherein an outer surface of the endless belt has longitudinally spaced tread members;
means for rotating of the drive wheel of the endless belt;
at least one electric generator housing, containing turbine generator, slidably mounted on the platform member, having at least one axle journalled for rotation between bearings contained in a electric generator housing, the axle having an external end protruding from a side of the electric generator housing;
a rotor gear coupled to the external end of the axle, wherein the rotor gear is in mating contact with the tread members of the endless belt.

2. The electric power generator of claim 1 further comprising:
means for routing electricity generated in the electric generator housing to power the means for rotating of the drive wheel of the endless belt.

3. The electric power generator of claim 1 further comprising:
at least one bumper stop mounted on the platform member, wherein the bumper stop prevents accidental dismounting of the electric generator housing from the platform member.

4. The electric power generator of claim 1 wherein:
a plurality of rollers is positioned on an underside of the electric generator housing, thereby allowing the electric generator housing to slide on the platform member.

5. The electric power generator of claim 1 further comprising:
a frame member coupled to the electric generator housing, wherein the frame member is slidably mounted on the platform member.

6. The electric power generator of claim 5 wherein:
the platform member has at least one rail for guiding movement of the frame member slidably mounted on the platform member.

7. The electric power generator of claim 1 wherein:
at least one translational gear is coupled to the rotor gear, wherein the translational gear is coupled to the axle, and wherein rotation of the rotor gear rotates the translational gear and rotation of the translational gear rotates the axle.

8. A electric power generator, comprising:
a platform member, having a horizontal longitudinal axis and means for changing of an angle of orientation of the platform member along the horizontal longitudinal axis;
at least one endless belt integrated with the platform member, having at least one drive wheel and at least one idler wheel, wherein an outer surface of the endless belt has longitudinally spaced tread members;
means for rotating of the drive wheel of the endless belt;
at least two electric generator housings, each containing turbine generators, slidably mounted on the platform member, having at least one joint axle journalled for rotation between bearings contained in electric generator housings, the joint axle having a central external portion located between the electric generator housings;
a rotor gear coupled to the central external portion of the joint axle, wherein the rotor gear is in mating contact with the tread members of the endless belt.

9. The electric power generator of claim 8 further comprising:
means for routing electricity generated in the electric generator housings to power the means for rotating of the drive wheel of the endless belt.

10. The electric power generator of claim 8 further comprising:
at least one bumper stop mounted on the platform member, wherein the bumper stop prevents accidental dismounting of the electric generator housings from the platform member.

11. The electric power generator of claim 8 wherein:
a plurality of rollers is positioned on an underside of each of the electric generator housings, thereby allowing the electric generator housings to slide on the platform member.

12. The electric power generator of claim 8 further comprising:
a frame member coupled to the electric generator housings, wherein the frame member is slidably mounted on the platform member.

13. The electric power generator of claim 12 wherein:
the platform member has at least one rail for guiding movement of the frame member slidably mounted on the platform member.

14. The electric power generator of claim 8 wherein:
at least one translational gear is coupled to the rotor gear, wherein the translational gear is coupled to the joint axle, and wherein rotation of the rotor gear rotates the translational gear and rotation of the translational gear rotates the joint axle.

15. A method of operation of the electric power generator, which comprises:
changing of an angle of orientation of a platform member along a horizontal longitudinal axis from 0° to an angle greater than 0°;
activating of means for rotating of a drive wheel of an endless belt, thereby initiating rotation of the drive wheel and initiating movement of the endless belt;
regulating speed of movement of the endless belt, wherein the endless belt is moving with sufficient speed to substantially maintain position of at least one electric generator housing on the platform member;
utilizing at least a portion of the electricity created by the generator to power the means for rotating of the drive wheel of the endless belt;
changing of an angle of orientation of the platform member along the horizontal longitudinal axis to regulate an electric output of the generator, wherein increase in the angle of orientation of the platform member along the horizontal longitudinal axis translates into greater electric output by the generator;
harvesting of the electricity generated by the generator.

16. A method of operation of the electric power generator of claim 13, which further comprises:
increasing of the weight of the electric generator housing to increase electric output of the generator.
